(19) United States
(12) Patent Application Publication
(10) Pub. No.: US 2025/0106220 A1
(43) Pub. Date: Mar. 27, 2025

(54) Cloud computer credential theft detection

(71) Applicant: PALO ALTO NETWORKS (ISRAEL ANALYTICS) LTD., Tel Aviv (IL)

(72) Inventors: Eden Elazar, Haifa (IL); Dror Alon, Rishon Lezion (IL); Aviad Meyer, Hod-Hasharon (IL); Or Kliger, Tel Aviv (IL); Zohara Zigdon, Ra’anana (IL)

(21) Appl. No.: 18/475,266

(22) Filed: Sep. 27, 2023

(51) Int. Cl. H04L 9/40; H04L 67/10

(52) U.S. Cl. CPC H04L 63/107; H04L 63/0807; H04L 67/10

(57) ABSTRACT

Methods, storage systems and computer program products implement embodiments of the present invention that detecting a security token received by a cloud-based service from a cloud-based computer, the security token issued by a token service and authorizing access to the cloud-based service. A first geographic region in which the security token is deployed is identified, and a second geographic region in which the cloud-based computer is deployed is also identified. Finally, upon detecting that the second geographic region does not match the first geographic region, an alert can be generated for the security token.

### FIELD OF THE INVENTION

The present invention relates generally to computer security and networks, and particularly to preventing cyberattacks on network services by detecting unauthorized use of security tokens.

### BACKGROUND OF THE INVENTION

Authentication and authorization are two critical concepts in access control. Authentication is essentially verifying the identity of an entity (e.g., a user or a computing resource such as a physical computers, virtual machines, and cloud-based resources and services). Authentication enables access control by proving that an entity's credentials match those in a database, thereby ensuring system security, process security, and corporate information security.

Authorization typically occurs system after a has successfully authenticated the identity of an entity. An authorization system will then allow access to resources such as information, files, databases, or specific operations and capabilities. After a system authenticates a user, the authorization system verifies access to the required resources. Authorization is the process of determining whether an authenticated user can access a particular resource or perform a specific action. For example, after a file server authorizes a user, the file server can determine which files or directories can be read, written, or deleted.

Some systems implement token-based authorization via the use of security tokens (also known as access tokens). Security tokens are used in token-based authentication to allow an application to access a service (e.g., a storage service). An entity receives a security token after being successfully authenticated. Upon receiving the access token, the entity can convey the security token as a credential when it conveys a request (e.g., an API call) to the service. The conveyed security token informs the service that the bearer of the security token has been authorized to access the service and perform specific actions specified by the scope that was granted during authorization.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method, including detecting a security token received by a cloud-based service from a cloud-based computer, the security token issued by a token service and authorizing access to the cloud-based service, identifying a first geographic region in which the security token is deployed, identifying a second geographic region in which the cloud-based computer is deployed, and generating an alert for the security token upon detecting that the second geographic region does not match the first geographic region.

In one embodiment, the cloud-based service executes on a cloud-based resource managed by a cloud service provider, and wherein detecting the security token includes detecting, by an endpoint security agent executing on the cloud-based resource, the security token, and conveying a notification to a security server.

In some embodiments, the cloud-based resource includes a first cloud-based resource, and wherein the security server includes a second cloud-based resource.

In another embodiment, the steps of identifying the first and the second geographic regions, and generating the alert are performed by the security server.

In an additional embodiment, the method further includes defining, by the security server, prior to identifying the first geographic region, a set of geographic regions including the first and the second geographic regions.

In a further embodiment, defining the set of geographic regions includes conveying, by the security server, a query to the cloud service provider, and receiving, by the security server, a response including the set of geographic regions.

In a supplemental embodiment, the method further includes mapping a set of geolocations to the set of geographic regions, and wherein identifying the second an IP address to which the security token was deployed, and mapping the IP address to the first geographic region includes identifying an Internet protocol (IP) address of the cloud-based computer, mapping the IP address to a given geolocation.

In another embodiment, the cloud-based resource manages an event log, and wherein identifying the first geographic region includes querying the event log and detecting, in the event log, an IP address to which the security token was deployed, and mapping the IP address to the first geographic region.

In an additional embodiment, identifying the first geographic region includes conveying a deployment query to the cloud provider, receiving, from the cloud provider, a response including an IP address to which the security token was deployed, and mapping the IP address to the first geographic region.

In some embodiments, the cloud-based computer includes a physical host computer.

There is also provided, in accordance with an embodiment of the present invention, a computer software product, the product including a non-transitory computer-readable medium, in which program instructions are stored, which instructions, when read by a computer, cause the computer to detect a security token received by a cloud-based service from a cloud-based computer, the security token issued by a token service and authorizing access to the cloud-based service, to identify a first geographic region in which the security token is deployed, to identify a second geographic region in which the cloud-based computer is deployed, and to generate an alert for the security token upon detecting that the second geographic region does not match the first geographic region.

There is additionally provided, in accordance with an embodiment of the present invention, a cloud-based resource, including a memory, and one or more processors configured to detect, in the memory, a security token received by a cloud-based service from a cloud-based computer, the security token issued by a token service and authorizing access to the cloud-based service, to identify a first geographic region in which the security token is deployed, to identify a second geographic region in which the cloud-based computer is deployed, and to generate an alert for the security token upon detecting that the second geographic region does not match the first geographic region.

### BRIEF DESCRIPTION OF THE DRAWINGS

The disclosure is herein described, by way of example only, with reference to the accompanying drawings, wherein:

FIG. 1 is a block diagram that shows an example of a set of cloud servers that can deploy cloud-based resources, in accordance with a first embodiment of the present invention;

FIG. 2 is a block diagram showing an example of a set of deployed cloud-based resources, in accordance with an embodiment of the present invention;

FIG. 3 is a block diagram showing a first example of a given cloud-based resource comprising a cloud-based service, in accordance with an embodiment of the present invention;

FIG. 4 is a block diagram showing a second example of a given cloud-based resource comprising a cloud manager, in accordance with an embodiment of the present invention;

FIG. 5 is a block diagram showing a third example of a given cloud-based resource comprising a cloud security server, in accordance with an embodiment of the present invention;

FIG. 6 is a block diagram showing a fourth example of a given cloud-based resource comprising a legitimate cloud host, in accordance with an embodiment of the present invention;

FIG. 7 is a block diagram showing a fifth example of a given cloud-based resource comprising a malicious cloud host, in accordance with an embodiment of the present invention;

FIG. 8 is a flow diagram that schematically illustrates a method of detecting use of a hijacked security token, in accordance with an embodiment of the present invention; and

FIG. 9 is a block diagram showing an example of a physical host computer that can attempt to use the hijacked security token, in accordance with an embodiment of the present invention.

### DETAILED DESCRIPTION OF EMBODIMENTS

Embodiments of the present invention provide methods and systems for recommending detecting use of stolen credentials for a cloud-based service. In embodiments described herein, the credentials may comprise a security token, and the abuse may comprise unauthorized use of the access token for exfiltrating sensitive data.

As described hereinbelow, a security token received by a cloud-based service from a cloud-based computer is detected, the security token issued by a token service and authorizing access to the cloud-based service. A first geographic region in which the security token is deployed is identified and a second geographic region in which the cloud-based computer is deployed is identified. Finally, the second geographic region is compared to the first geographic region, and an alert is generated for the security token if the second geographic region does not match the first geographic region.

### System Description

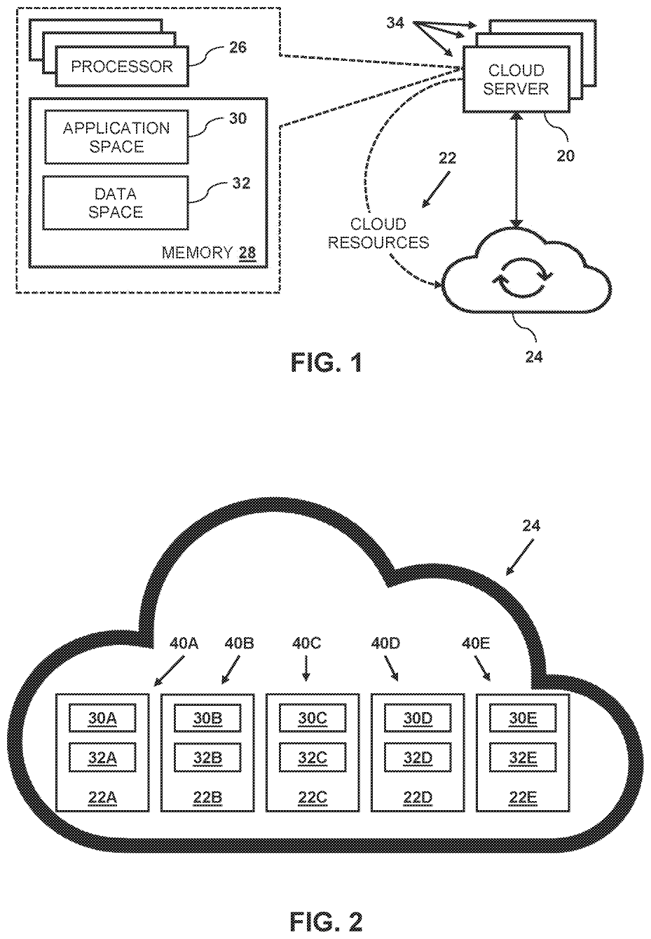

FIG. 1 is a block diagram that schematically shows an example of a set of cloud servers 20 that can deploy cloud-based resources 22 over a public network 24 such as the Internet (also referred to herein as Internet 24), in accordance with a first embodiment of the present invention.

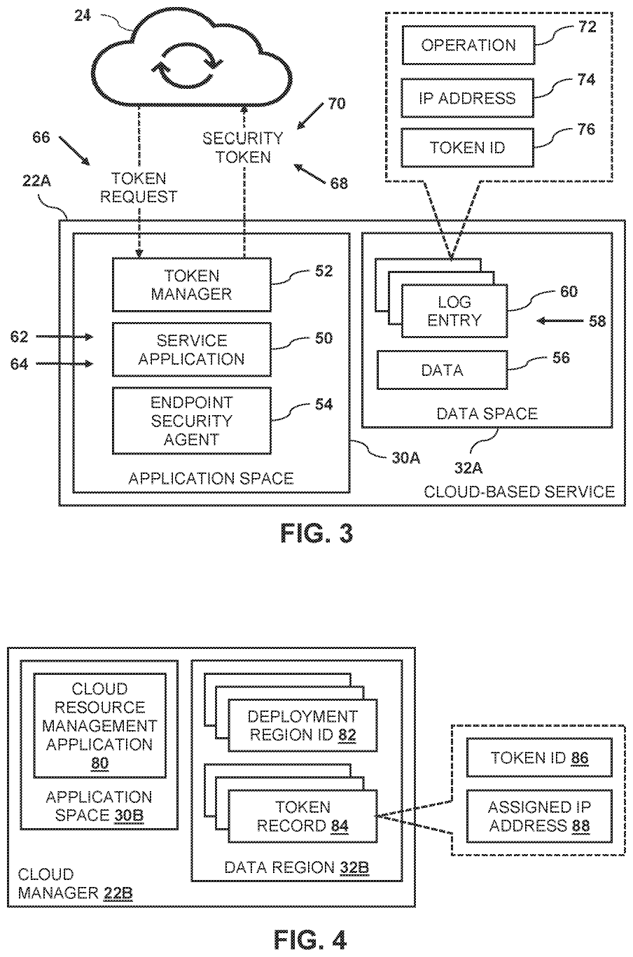

In the configuration shown in FIG. 1, each cloud server 20 is coupled to Internet 24, and comprises one or more processors 26 and a memory 28. When deploying cloud-based resources 22, memory 28 comprises an application space 30 that stores one or more executable software applications and a data space 32 that stores data used by the application. Configuration of spaces 30 and 32 is described in the description referencing FIGS. 3-7 hereinbelow.

Each cloud server 20 belongs to a respective cloud service provider 34. Examples of cloud service providers 34 include, but are not limited to:
AMAZON WEB SERVICES™ (AWS™), provided by AMAZON. COM, INC., 410 Terry Avenue North, Seattle, WA, USA.
GOOGLE CLOUD PLATFORM™ (GCP™), provided by ALPHABET INC., 1600 Amphitheatre Parkway, Mountain View, CA, USA.
MICROSOFT AZURE™, produced by MICROSOFT CORPORATION, One Microsoft Way, Redmond, WA, USA.

Processors 26 comprise general-purpose central processing units (CPU) or special-purpose embedded processors, which are programmed in software or firmware to carry out the functions described herein. This software may be downloaded to cloud servers 20 in electronic form, over a network, for example. Additionally or alternatively, the software may be stored on tangible, non-transitory computer-readable media, such as optical, magnetic, or electronic memory media. Further additionally or alternatively, at least some of the functions of processors 26 may be carried out by hard-wired or programmable digital logic circuits.

Examples of memories 28 include dynamic random-access memories, non-volatile random-access memories, hard disk drives and solid-state disk drives.

FIG. 2 is a block diagram showing an example of a set of cloud-based resources 22 deployed in Internet 24, in accordance with an embodiment of the present invention. In the configuration shown in FIG. 2, cloud-based resources 22 comprise (i.e., can be referenced by and/or accessed via) respective Internet Protocol (IP) addresses 40.

In embodiments presented herein, cloud-based resources 22 and their respective components can be differentiated by appending a letter to the identifying numeral, so that the cloud-based resources comprise cloud-based resources 22A-22E, the application spaces comprise application spaces 30A-30E, the data spaces comprise data spaces 32A-32E, and the IP addresses comprise IP addresses 40A-40E. In these embodiments:
Cloud-based resource 22A may also be referred to as cloud-based service 22A, and comprises application space 30A, data space 32A and IP address 40A.
Cloud-based resource 22B may also be referred to as cloud manager 22B, and comprises application space 30B, data space 32B and IP address 40B.
Cloud-based resource 22C may also be referred to as cloud security server 22C, and comprises application space 30C, data space 32C and IP address 40C.
Cloud-based resource 22D may also be referred to as legitimate cloud host 22D, and comprises application space 30D, data space 32D and IP address 40D.
Cloud-based resource 22E may also be referred to as malicious cloud host 22E, and comprises application space 30E, data space 32E and IP address 40E.

FIG. 3 is a block diagram showing components stored in application space 30A and data space 32A (i.e., in cloud-based service 22A), in accordance with an embodiment of the present invention. In the configuration shown in FIG. 3, application space 30A comprises a service application 50, a token manager 52 and an endpoint security agent 54, and data space 32A comprises data 56 and an event log 58 comprising a set of log entries 60. Log entries 60 are described hereinbelow.

Cloud-based resource 22A can execute service application 50 so as to provide a service 62 referenced by a unique service identifier (ID) 64. For example, service 62 for service application 50 may comprise a storage service or a database service that manages data 56.

While executing in cloud-based resource 22A, in response to receiving a token request 66 from a given cloud-based resource 22, token manager 52 generates a new security token 68, and conveys the generated security to the given cloud-based resource. The given cloud-based resource can then convey the generated security token to service application 50 so as to gain access to the service application as an authenticated user.

In embodiments described herein security token 68 comprises a token ID 70.

For purposes of visual simplicity, the configuration in FIG. 3 shows token manager 52 and service application 50 both executing in (the same) cloud-based resource 22A. In other (and more typical) configurations, token manager 52 and service application 50 execute in different cloud-based resources 22.

Endpoint security agent 54 comprises a software application that executes (typically in the background) on cloud-based resource 22A so as to identify any vulnerabilities in real-time. One example of a given endpoint security agent 44 is CORTEX XDRIM (produced by PALO ALTO NETWORKS INC.).

Using embodiments described hereinbelow, upon endpoint security agent 54 detecting service application 50 receiving a given security token 68 from a given computing device (e.g., a given cloud-based resource 22) having a given IP address 40, the endpoint security agent can convey the received security token and the given IP address to cloud security server 22C for inspection.

In some embodiments, token manager 52 can generate respective log entries 60 upon generating security tokens 68. Likewise, service application 50 can generate respective log entries 60 upon receiving, from cloud-based resources 22, access requests for service 62, each of the access requests comprising a given security token 68. In these embodiments, each log entry 60 can store information such as:
An operation ID 72 indicating an action such as issuing a new security token 68 or receiving a given previously issued security token 68. In examples described hereinbelow, operation ID 72 for issuing a new security token 68 is “I”, and operation ID 72 receiving a given previously issued security token 68 is “R”.
An IP address 74 referencing a given cloud host 22D.
A token ID 76 comprising token ID 70 for the given security token.

In a first log entry example, token manager 52 generates a first given security token 68 in response to receiving a request from cloud host 22D. Upon generating the first given token, token manager 52 can generate a new log entry 60, and populate the new log entry as follows:
Store “I” to operation ID 72.
Store IP address 40D (i.e., the IP address for cloud host 22D) to IP address 74.
Store token ID 70 for the first given token to token ID 76.

In a second log entry example, service application 50 generates a second given security token 68 in response to receiving, from a given cloud-based resource 22, a request to access service 62, the request comprising a given token ID 70. Upon receiving the request, token manager 52 can generate a new log entry 60, and populate the new log entry as follows:
Store “R” to operation ID 72.
Store IP address 40 for the given cloud-based resource to IP address 74.
Store the received token ID to token ID 76.

FIG. 4 is a block diagram showing components stored in application space 30B and data space 32B (i.e., in cloud manager 22B), in accordance with an embodiment of the present invention. In some embodiments, a given cloud service provider 34 can deploy cloud manager 22B so as to configure and manage cloud-based resources 22 deployed by the given cloud service provider.

In the configuration shown in FIG. 4, application space 30B comprises a cloud resource management application 80, and data space 32B comprises a set of deployment region IDs 82 and a set of token records 84. In some embodiments, cloud manager 22B can define the set of deployment region IDs 82 that respectively reference geographic regions (e.g., continents, countries, cities, etc.).

Token records 84 correspond to security tokens 68 and may comprise information such as:
A token ID 86 comprising token ID 70 for the corresponding security token.
An assigned IP address 88. In some embodiments, as described supra, token service 52 generates a new security token 68 (i.e., the corresponding security token) in response to receiving a request from cloud host 22D. In these embodiments assigned IP address 88 comprises IP address 40D. In other words, token service 52 “assigns” the security token corresponding to token ID 86 is to cloud host computer 22D.

In some embodiments, cloud manager can use token records 84 to track the security tokens generated by token manager 52. In these embodiments, upon generating, for a given cloud-based service 22 comprising a given IP address 40, a given security token 68 comprising a given token ID 70, token manager 52 can notify cloud manager 22B. Upon receiving the notification, cloud manager 22B can add a new token record 84, and store the given token ID and the given IP address respectively to token ID 86 and assigned IP address 88 in the new token record.

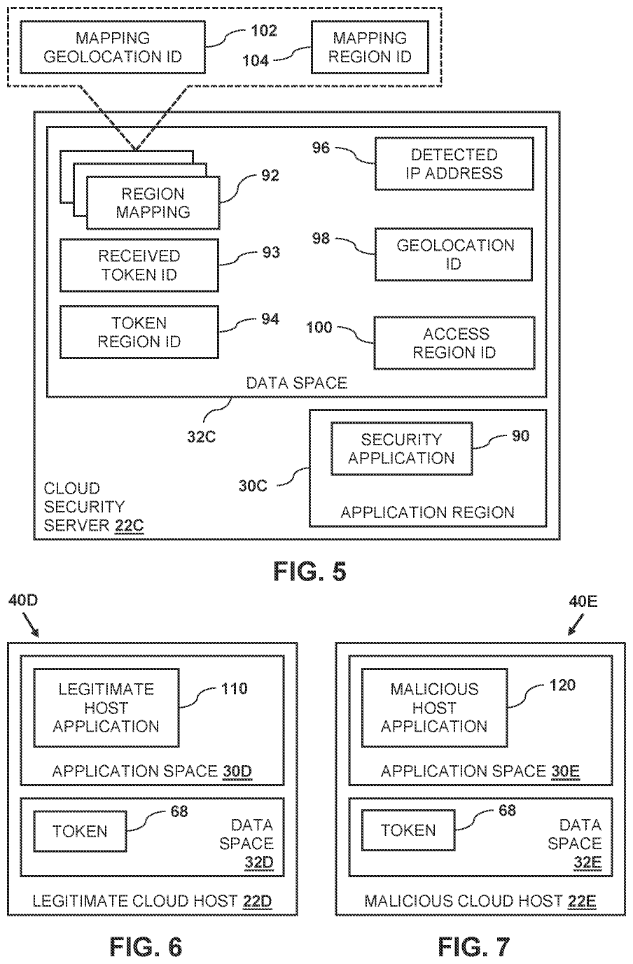

FIG. 5 is a block diagram showing components stored in application space 30C and data space 32C (i.e., in cloud security server 22 22C), in accordance with an embodiment of the present invention. In the configuration shown in FIG. 5, application space 30C comprises a security application 90, and data space 32C comprises a set of region mappings 92, a received token ID 93, a token region ID, a detected IP address 96, an identified geolocation ID 98 and an access region ID 100.

Each region mapping 92 comprises a mapping geolocation ID 102 and a corresponding mapping region ID 104 comprising a given token region ID 94 so as to reference a specific geographic region. In some embodiments, a given mapping geolocation ID 102 may comprise a city (e.g., New York) or a state (e.g., Florida), and a given mapping region ID 104 may reference a specific geographic region such as a continent, a country, a city or an area. For example, if a given mapping geolocation ID 102 references Boston, its corresponding region ID 104 may reference North America, New England (e.g., a geographic region comprising Connecticut, Maine, Massachusetts, New Hampshire, Rhode Island, and Vermont), Massachusetts or Boston.

Some mapping region IDs 104 may map to more than one mapping geolocation IDs 102 (in other words, there may be multiple region mappings 92 comprising a given mapping region ID 104). For example, if a given mapping region ID 104 references New England, there can be multiple region mappings 92 for New England, since mapping geolocation IDs 102 referencing the cities Boston, New Haven, Portland and Providence are all in New England.

In embodiments described herein, mapping region IDs 104 correspond to deployment region IDs 82, and token region ID 94 comprises a given mapping region ID 104. Therefore, token region ID 94 references a given deployment region ID 82 where token manager 52 deployed security token 86. Typically, this means that security token 68 is configured to be available to cloud-based resources 22 that are deployed in geolocations that map to the given deployment region ID.

FIG. 6 is a block diagram showing components stored in application space 30D and data space 32D (i.e., in legitimate cloud host 22D), in accordance with an embodiment of the present invention. As in embodiments herein, legitimate cloud host 22D can be accessed via IP address 40D.

In the configuration shown in FIG. 6, application space 30D comprises a legitimate host application 110, and data space 32D comprises a given security token 68. In embodiments herein, while executing on legitimate cloud host 22D, token manager 52 conveyed a given security token 68 to host 22D, and host application 110 can access data 56 upon conveying the given security token to service application 50 so as to register and authenticate cloud host 22D as a legitimate client for service 62.

FIG. 7 is a block diagram showing components stored in application space 30E and data space 32E (i.e., in malicious cloud host 22E), in accordance with an embodiment of the present invention. As in embodiments herein, malicious cloud host 22E can be accessed via IP address 40E.

In the configuration shown in FIG. 7, application space 30E comprises a malicious host application 120, and data space 32E comprises a given security token 68. In embodiments herein, while executing on malicious cloud host 22E, malicious host application 120 hijacked the given security token, and can gain access to data 56 upon conveying the hijacked security token to service application 50.

### Hijacked Token Access Detection

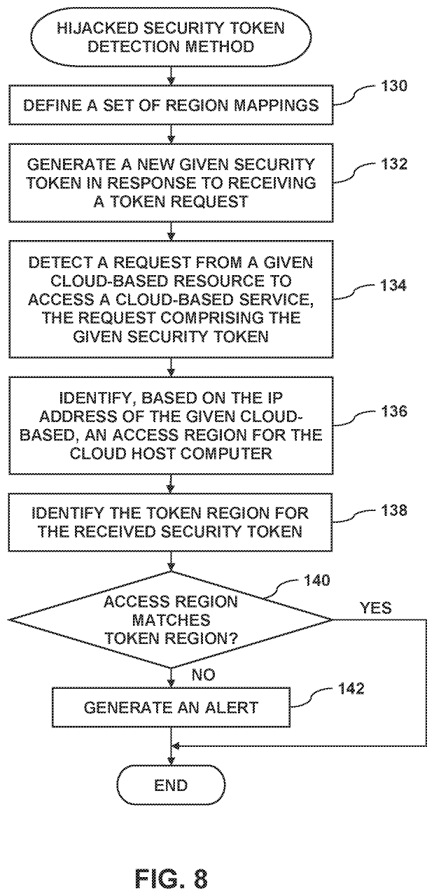

FIG. 8 is a flow diagram that schematically illustrates a method of detecting a use of given security token 68 that was hijacked and thereby compromised, in accordance with an embodiment of the present invention. In some embodiments described herein, the compromised token comprises a given security token that was leaked to or stolen by a malicious actor who uses malicious cloud host 22E to access service 68 with the comprised token.

In step 130, security server 22C defines region mappings 92. To define region mappings 92, security server 22C can specify a set of mapping geolocation IDs 102, and for each given mapping geolocation ID 102, generate a new region mapping 92, generate a new mapping region ID 104 for the given mapping geolocation, and store the given mapping geolocation and the given mapping regions ID 104 to the new region mapping.

As described supra, mapping region IDs correspond to deployment region IDs 82 (i.e., the deployment region IDs for cloud service provider 34). Therefore, security server 22C can generate mapping region IDs 104 by retrieving deployment region IDs 82.

In step 132, in response to receiving a new token request 66 from cloud host 22D having IP address 40D, token manager 52 generates a new given security token 68 with a new token ID 70. Upon generating the new security token, token manager 52 can generate a new log entry 56, and store the new token ID 70 and IP address 40D to the new log entry using embodiments described hereinabove.

In some embodiments, upon generating the new given security token, token manager 52 (or service application 50) can convey, to cloud manager 22B, a message comprising the new token ID 70 and IP address 40D. Upon receiving the message, cloud manager 22B can add a new token record 84, store the received token ID to token ID 86 in the new token record, and store the received IP address to assigned IP address 88 in the new token record.

In step 134, endpoint security agent 54 detects a given cloud-based resource 22 comprising a given IP address 40 requesting access to service 62 by conveying the given security token 68 (i.e., the security token generated in step 132) to service application 50. In some embodiments, in response to receiving the access request, service application 50 can add a new log entry 60, and populate the new log entry using embodiments described hereinabove. For example, service application 50 can store, to the new log entry, the IP address of the given cloud-based service to IP address 74 and the token ID for the received security token to token ID 76.

While embodiments describe herein describe detecting access requests (i.e., comprising security token 68 for service 62) from cloud-based resources 22 (e.g., cloud-based resources 22D and 22E), detecting and analyzing access requests from a physical computer is considered to be within the spirit and scope of the present invention.

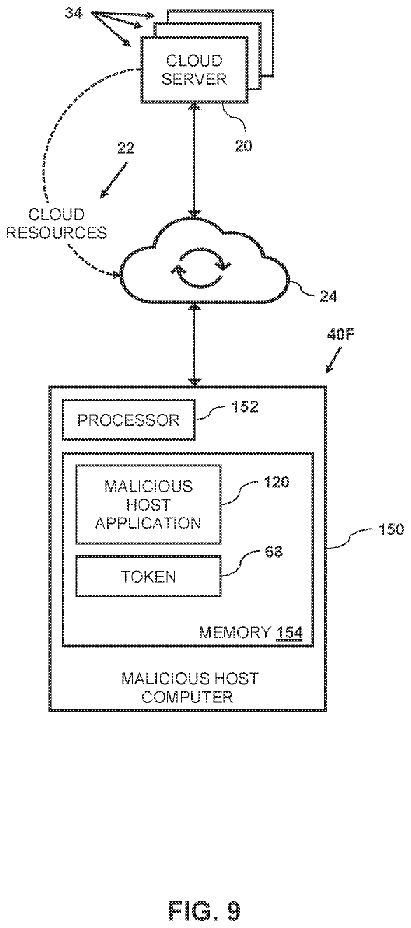

FIG. 9 is a block diagram showing an example of a physical host computer 150 that can attempt to use the hijacked security token, in accordance with an embodiment of the present invention. In the configuration shown in FIG. 9, physical host computer 150 has IP address 40F, and comprises a processor 152 and a memory 154 comprising hijacked security token 68 and malicious host application 120 that the processor can execute from the memory. In embodiment where security server detects and analyzing access requests from physical host computer 150, the physical host computer may be referred to herein as a given cloud-based resource 22.

In some embodiments, endpoint security agent 54 can detect the access request by monitoring event log 58 and detecting the new log entry. Upon detecting the new log entry, endpoint security agent 54 can convey, to security server 22C, a notification comprising the IP address of the given cloud-based service and the token ID for the received security token. Upon receiving the notification, security server 22C can store the received token ID to received token ID 93, and store the received IP address to detected IP address 96.

In step 136, security server 22C identifies, based on detected IP address 96, geolocation ID 98. In some embodiments, endpoint security agent 54 can use the GEOIP™ (provided by MAXMIND INC., 410 Terry Avenue North Seattle, WA 98109 USA) service so as to identify geolocation ID 98 for the detected IP address.

Security server 22C can then compare geolocation ID 98 to mapping geolocation IDs 102, so as to detect a match between geolocation ID 98 and a given mapping geolocation ID 102 in a given region mapping 92. Upon detecting the match, security server 22C can then store, to access region ID 100, mapping region ID 104 in the given region mapping.

In step 138, security server 22C identifies token region ID 94 for received token ID 93.

In one embodiment, endpoint security agent 54 can convey, to endpoint security agent 54, a query comprising received token ID 93 so as to identify token region ID 94. As described supra, data space 32A comprises event log 58 comprising log entries 60, and service application 50 can create a given log entry 60 that stores configuration information for the service application, including deployed token IDs 70 for security tokens 68 and their respective IP addresses 40 (i.e., for the cloud-based services to which the security tokens were deployed. In this embodiment:
In response to receiving the query comprising received token ID 93, endpoint security agent 54 can identify the log entry for token manager 52 issuing the security token corresponding to received token ID 93, and convey, to security server 22C in response to the query, IP address 74 for in the identified log entry.
Using embodiments described hereinabove (e.g., using the GEOIP™ service), security server 22C can use the received IP address 74 so as to identify token region ID 94 for received token ID 93.

In another embodiment, endpoint security agent 54 can convey, to query cloud manager 22B, a query comprising received token ID 93 so as to identify token region ID 94. As described in the description referencing FIG. 2 hereinabove, cloud manager 22B can store token records 84 that store token IDs 86 and their corresponding IP addresses 88. In this embodiment:
In response to receiving the query comprising received token ID 93, cloud manager 22B can identify the token record comprising received token ID 93 received token ID 93, and convey, to security server 22C in response to the query, assigned IP address 88 in the identified token record.
Using embodiments described hereinabove (e.g., using the GEOIP™ service) security server 22C can use the received assigned IP address 88 so as to identify token region ID 94 for received token ID 93.

In step 140, security server 22C compares access region ID 100 to token region ID 94. In embodiments herein, if access region ID 100 differs from token region ID 94, then there is a good chance that the security token corresponding to token ID 93 is compromised/hijacked. For example, if token region ID 94 references a first region in the United States, and host geolocation ID 98 references a second region in Europe, this activity is suspicious.

If token region ID 94 does not match access region ID 100, then in step 142, endpoint security agent 54 generates an alert, and the method ends. For example, token region ID 94 for the given security token references Minnesota USA, and malicious cloud host 22D, whose geolocation ID 98 for IP address 40E references Spain, conveys the given security token to service application 50. In some embodiments, endpoint security agent 54 can generate the alert by performing operations such as conveying a message to a systems administrator, cancelling the given (i.e., received) security token, or terminating the connection between cloud-based resources 22A and 22E.

Returning to step 140, if token region ID 94 matches access region ID 100, then the method ends. In this instance, the use of the given token is not suspicious since the given security token and the given cloud-based resource are both deployed to the same geographic region. For example, token region ID 94 for the given security token references Minnesota USA, and malicious cloud host 22D, whose geolocation ID 98 for IP address 40D also references Minnesota, conveys the given security token to service application 50.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
detecting a security token received by a cloud-based service from a cloud-based computer, the security token issued by a token service and authorizing access to the cloud-based service;
identifying a first geographic region in which the security token is deployed;
identifying a second geographic region in which the cloud-based computer is deployed; and
generating an alert for the security token upon detecting that the second geographic region does not match the first geographic region.

2. The method according to claim 1, wherein the cloud-based service executes on a cloud-based resource managed by a cloud service provider, and wherein detecting the security token comprises detecting, by an endpoint security agent executing on the cloud-based resource, the security token, and conveying a notification to a security server.

3. The method according to claim 2, wherein the cloud-based resource comprises a first cloud-based resource, and wherein the security server comprises a second cloud-based resource.

4. The method according to claim 2, wherein the steps of identifying the first and the second geographic regions, and generating the alert are performed by the security server.

5. The method according to claim 4, and further comprising defining, by the security server, prior to identifying the first geographic region, a set of geographic regions comprising the first and the second geographic regions.

6. The method according to claim 5, wherein defining the set of geographic regions comprises conveying, by the security server, a query to the cloud service provider, and receiving, by the security server, a response comprising the set of geographic regions.

7. The method according to claim 5, and further comprising mapping a set of geolocations to the set of geographic regions, and wherein identifying the second an IP address to which the security token was deployed, and mapping the IP address to the first geographic region comprises identifying an Internet protocol (IP) address of the cloud-based computer, mapping the IP address to a given geolocation.

8. The method according to claim 4, wherein the cloud-based resource manages an event log, and wherein identifying the first geographic region comprises querying the event log and detecting, in the event log, an IP address to which the security token was deployed, and mapping the IP address to the first geographic region.

9. The method according to claim 4, wherein identifying the first geographic region comprises conveying a deployment query to the cloud provider, receiving, from the cloud provider, a response comprising an IP address to which the security token was deployed, and mapping the IP address to the first geographic region.

10. The method according to claim 1, wherein the cloud-based computer comprises a physical host computer.

11. A computer software product, the product comprising a non-transitory computer-readable medium, in which program instructions are stored, which instructions, when read by a computer, cause the computer:
to detect a security token received by a cloud-based service from a cloud-based computer, the security token issued by a token service and authorizing access to the cloud-based service;
to identify a first geographic region in which the security token is deployed;
to identify a second geographic region in which the cloud-based computer is deployed; and
to generate an alert for the security token upon detecting that the second geographic region does not match the first geographic region.

12. The computer software product according to claim 11, wherein the cloud-based service executes on a cloud-based resource managed by a cloud service provider, wherein the program instructions are configured to detect the security token by detecting, by an endpoint security agent executing on the cloud-based resource, the security token, and conveying a notification to a security server.

13. The computer software product according to claim 12, wherein the cloud-based resource comprises a first cloud-based resource, and wherein the security server comprises a second cloud-based resource.

14. The computer software product according to claim 12, wherein the program instructions that identify the first and the second geographic regions, and generate the alert are performed by the security server.

15. The computer software product according to claim 14 wherein the program instructions are further configured to define, by the security server, prior to identifying the first geographic region, a set of geographic regions comprising the first and the second geographic regions.

16. The computer software product according to claim 15, wherein the program instructions are configured to define the set of geographic regions by conveying, by the security server, a query to the cloud service provider, and receiving, by the security server, a response comprising the set of geographic regions.

17. The computer software product according to claim 15, wherein the program instructions are further configured to map a set of geolocations to the set of geographic regions, and wherein the program instructions are configured to identify the second geographic region comprises identifying an Internet protocol (IP) address of the cloud-based computer, mapping the IP address to a given geolocation.

18. The computer software product according to claim 14, wherein the cloud-based resource manages an event log, and wherein the program instructions are configured to identify the first geographic region by querying the event log and detecting, in the event log, an IP address to which the security token was deployed, and mapping the IP address to the first geographic region.

19. The computer software product according to claim 14, wherein the program instructions are configured to identify the first geographic region by conveying a deployment query to the cloud provider, receiving, from the cloud provider, a response comprising an IP address to which the security token was deployed, and mapping the IP address to the first geographic region.

20. The computer software product according to claim 11, wherein the cloud-based computer comprises a physical host computer.

21. A cloud-based resource, comprising:
a memory; and
one or more processors configured:
to detect, in the memory, a security token received by a cloud-based service from a cloud-based computer, the security token issued by a token service and authorizing access to the cloud-based service,
to identify a first geographic region in which the security token is deployed,
to identify a second geographic region in which the cloud-based computer is deployed, and
to generate an alert for the security token upon detecting that the second geographic region does not match the first geographic region.
